(19) United States
(12) Patent Application Publication
(10) Pub. No.: US 2025/0355222 A1
(43) Pub. Date: Nov. 20, 2025

(54) CONTROL DEVICE, CONTROL METHOD, AND STORAGE MEDIUM

(71) Applicant: CANON KABUSHIKI KAISHA, Tokyo (JP)

(72) Inventor: ATSUSHI KATO, Kanagawa (JP)

(21) Appl. No.: 19/172,088

(22) Filed: Apr. 7, 2025

(30) Foreign Application Priority Data
May 17, 2024 (JP) 2024-081122

(51) Int. Cl. G02B 7/28; G02B 7/10

(52) U.S. Cl. CPC G02B 7/282; G02B 7/102

(57) ABSTRACT

A control device includes: a first target position generation unit configured to generate a first target position serving as a movement target of the first driving member on the basis of a target speed of a first driving member; a first control unit configured to control a position of the first driving member so that the first driving member follows the first target position; a second target position generation unit configured to generate a second target position serving as a movement target of a second driving member in accordance with an actual position of the first driving member or the first target position; and a second control unit configured to control a position of the second driving member so that the second driving member follows the second target position.

### BACKGROUND OF THE INVENTION

### Field of the Invention

The present invention relates to a control device, a control method, a storage medium, and the like.

### Description of the Related Art

As one of methods for controlling a multi-group zoom lens, a method of controlling a lens by setting a movement target for another lens on the basis of the movement locus of one reference lens is known. For example, Japanese Patent Laid-Open Publication No. 2013-134408 proposes a method of controlling lenses on the basis of information regarding a position and a speed of each of the lenses corresponding to a focal length. Also, Japanese Patent Laid-Open Publication No. H8-327876 proposes a method of controlling lenses in which each of the lenses takes into account its own and other lens position information and estimated disturbances.

Here, a lens speed is disturbed due to disturbances such as jitter and the movement locus of a reference lens is disturbed. Then, other lens in which a movement target is set on the basis of this movement locus is also disturbed. Also, in addition to the disturbance of the reference lens, velocity disturbance due to disturbances caused by the other lenses themselves is also superimposed, resulting in a larger disturbance, which deteriorates the zoom tracking performance and generates noise.

On the other hand, Japanese Patent Laid-Open Publication No. 2013-134408 includes controlling the lens position and speed based on the focal length, but does not take into account speed variations due to jitter or disturbances. Also, although Japanese Patent Laid-Open Publication No. H8-327876 includes controlling lenses so that each of the lenses takes into account its own and other lens position information and estimated disturbances, jitter and disturbances are difficult to estimate because they change from moment to moment in accordance with not only individual differences but also the environment.

### SUMMARY OF THE INVENTION

A control device according to an aspect of the present invention comprises:
a first target position generation unit configured to generate a first target position serving as a movement target of a first driving member on the basis of a target speed of the first driving member;
a first control unit configured to control a position of the first driving member so that the first driving member follows the first target position;
a second target position generation unit configured to generate a second target position serving as a movement target of a second driving member in accordance with an actual position of the first driving member or the first target position; and
a second control unit configured to control a position of the second driving member so that the second driving member follows the second target position.

Further features of the present invention will become apparent from the following description of embodiments with reference to the attached drawings.

### BRIEF DESCRIPTION OF THE DRAWINGS

FIG. 1 is a diagram showing an example of a configuration of a lens barrel according to an embodiment of the present invention.

FIGS. 2A and 2B are diagrams showing an example of a schematic configuration of a motor unit according to an embodiment of the present invention.

FIG. 3 is a functional block diagram showing an example of a configuration of a lens control system according to an embodiment of the present invention.

FIGS. 4A to 4E are diagrams showing an example of processing of an encoder 305 in an embodiment of the present invention.

FIGS. 5A to 5C and 5E to 5I are diagrams showing a flow of processing of a lead angle and power rate control unit 308 and a drive waveform generation unit 309 in an embodiment of the present invention.

FIG. 6 is a diagram showing an example of a relationship between a lead angle and a motor rotation speed according to an embodiment of the present invention.

FIG. 7 is a flowchart for explaining an example of processing the lead angle and power rate control unit 308 according to an embodiment of the present invention.

FIG. 8 is a flowchart for explaining a target lead angle and power rate selection process in Step S710.

FIG. 9 is a flowchart for explaining an example of processing of a lead angle and power rate control unit in Step S711.

FIG. 10 is a flowchart for explaining an example of a target position counter value generation process of a first zoom lens 102 according to an embodiment of the present invention.

FIG. 11 is a flowchart for explaining an example of a target position counter value generation process of a second zoom lens 103 according to an embodiment of the present invention.

FIG. 12 is a diagram showing an example of a positional relationship of the first zoom lens 102 and the second zoom lens 103 according to an embodiment of the present invention.

### DESCRIPTION OF THE EMBODIMENTS

Hereinafter, with reference to the accompanying drawings, favorable modes of the present invention will be described using Embodiments. In each diagram, the same reference signs are applied to the same members or elements, and duplicate description will be omitted or simplified.

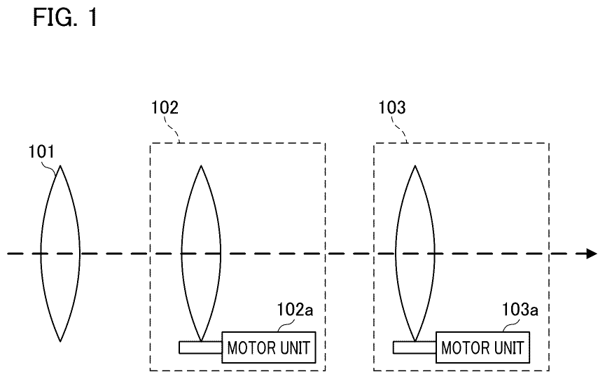

FIG. 1 is a diagram showing an example of a configuration of a lens barrel according to an embodiment of the present invention. A lens barrel shown in FIG. 1 constitutes an imaging optical system and includes, in order from a subject side (the left side of the drawing), a fixed lens 101, a first zoom lens 102, a second zoom lens 103. The lens barrel in the present embodiment also includes a focus lens (not shown). The first zoom lens 102 and the second zoom lens 103 function as a first driving member and a second driving member, respectively.

A first motor unit which moves the first zoom lens 102 in an optical axis direction so that zooming is performed is denoted by reference symbol 102a. A second motor unit which assists zooming using the first zoom lens 102 by moving the second zoom lens 103 in the optical axis direction in conjunction with a change in the position of the first zoom lens 102 is denoted by reference symbol 103a.

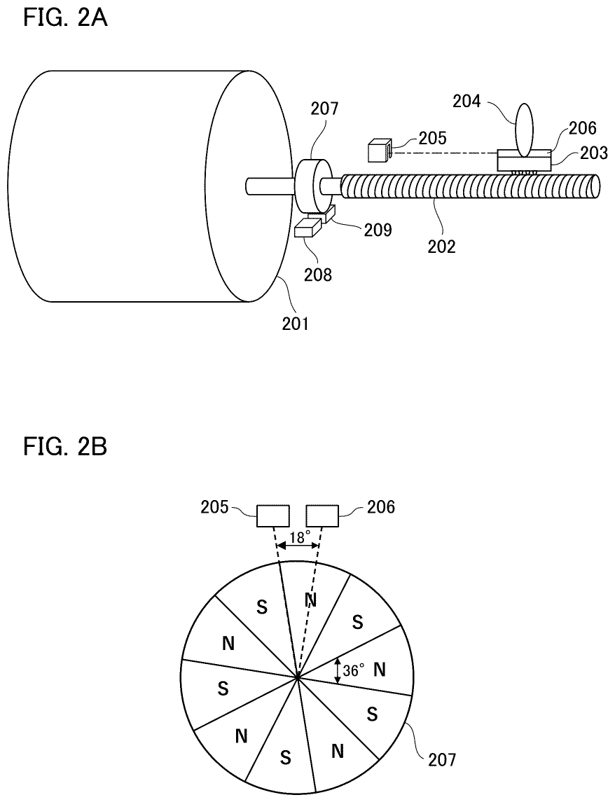

Next, FIGS. 2A and 2B are diagrams showing an example of a schematic configuration of the motor units according to an embodiment of the present invention. The motor units shown in FIGS. 2A and 2B are installed on the lenses, respectively and correspond to the first motor unit and the motor unit which drive the lenses independently. That is to say, the plurality of motor units are configured to drive the plurality of lenses which constitute a photographing lens, respectively.

In FIG. 2A, a stepping motor is denoted by reference numeral 201, a rotating shaft of the stepping motor 201 is denoted by reference numeral 202, and a rack is denoted by reference numeral 203. The rotating shaft 202 is a lead screw and engages with a rack 203 so that a lens 204 connected to the rack 203 moves in the optical axis direction in response to the rotation of the rotating shaft 202.

A reference position of each of the lenses is determined through a configuration of a photointerrupter (PI) 205 disposed on a fixture member (not shown) and a light blocking plate 206 provided on the lens. The PI 205 is composed of a light emitting unit and a light receiving unit. In addition, if the light blocking plate 206 is placed between the light emitting unit and the light receiving unit as the lens 204 moves, a detection signal of the PI 205 switches from High to Low.

This switching position is set as the reference position of the lens. A cylindrical magnet for detecting a rotational phase attached to the rotating shaft 202 is denoted by reference numeral 207 and detects a rotational phase of the stepping motor 201 in combination with Hall sensors 208 and 209 for detecting a rotational phase. Hereinafter, the Hall sensors 208 and 209 for detecting a rotational phase are referred to as Hall-ch0 and Hall-ch1, respectively.

FIG. 2B is a diagram for explaining the disposition of the magnet 207 for detecting a rotational phase and the Hall sensors 208 and 209 for detecting a rotational phase if the number of poles of the stepping motor 201 is 10. The magnet 207 for detecting a rotational phase is composed of a 10-pole magnet so that the number thereof matches the number of motor poles.

The poles are evenly spaced with a mechanical angle of 36°. The Hall sensors 208 and 209 for detecting a rotational phase are disposed on an extension line of the magnet 207 for detecting a rotational phase at a mechanical angle of 18°. With this configuration, two types of sine waves with a phase difference of 90° are detected from each of the Hall sensor in response to the rotation of the motor.

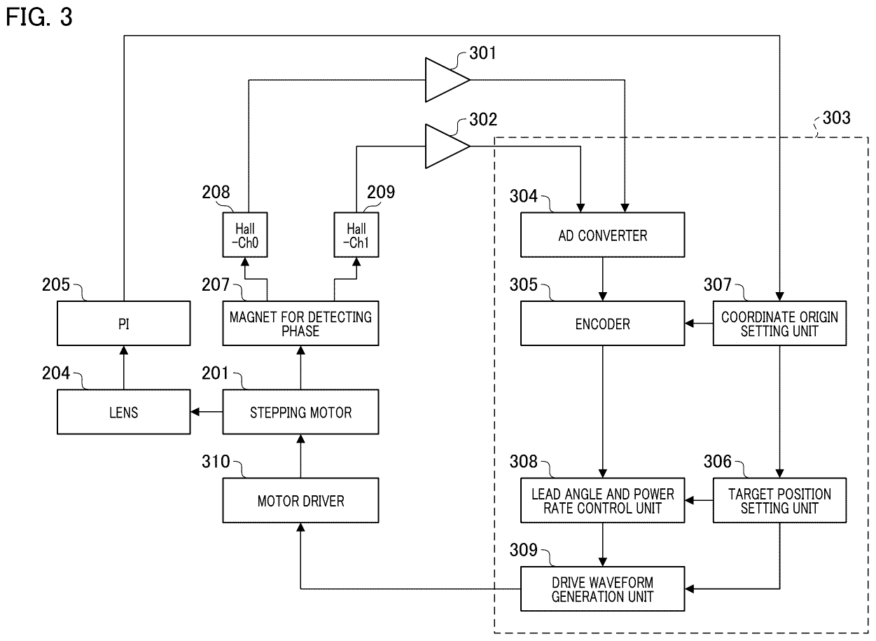

Next, FIG. 3 is a functional block diagram showing an example of a configuration of a lens control system according to an embodiment of the present invention. This system is configured to control the motor units provided in the lenses in conjunction with each other. Some of the functional blocks shown in FIG. 3 are realized by causing a CPU or the like serving as a computer (not shown) included in the lens control system to execute a computer program stored in a memory serving as a storage medium (not shown).

Here, some or all of these may be realized using hardware. As the hardware, a dedicated circuit (ASIC), a processor (reconfigurable process, DSP), or the like can be used.

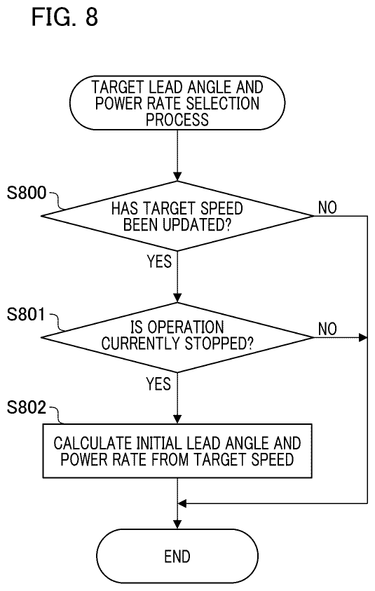

Also, the respective functional blocks shown in FIG. 3 do not need to be built in the same housing and may be configured as separate devices connected to each other via signal paths. Similarly, the above explanation provided with reference to FIG. 3 applies to FIG. 8.

In FIG. 3, blocks having the same numbers as those in FIG. 2 are the same members. Two-phase Hall signals detected using Hall-ch0 and Hall-ch1 are amplified using amplifier circuits 301 and 302, respectively. The amplified two-phase Hall signals are quantized using an AD converter 304 in the motor control device 303 and are encoded using an encoder 305 to calculate a position detection counter value.

FIG. 3 shows a configuration in which a motor control device 303 controls a set of motor units 201, 204, 205, 207 to 209, 301, 302, and 310. However, in the present embodiment, the single motor control device 303 is configured to control a plurality of motor units. Here, the motor control device 303 may be provided for each of the motor units.

The motor control device 303 has a built-in CPU or the like as a computer and functions as a control unit which controls an operation of each part of the entire motor control device on the basis of a computer program stored in a memory serving as a storage medium.

The encoder 305 generates a position detection counter value indicating position information of the lens 204 as a member connected to the motor. Although an example in which a position detection counter value is calculated using Hall sensors is described in the present embodiment, the present invention is not limited thereto. Instead of the Hall sensors, a photointerrupter and a slit rotating plate may be used for calculating a position detection counter value from a rotation detection pulse.

A target position setting unit which sets target positions of the lenses is denoted by reference numeral 306 and generates a target position counter value for controlling each of the lenses at a target speed and a target position. That is to say, the target position setting unit 306 generates a target position counter value so that the first zoom lens 102 has a target zoom speed.

Here, the target position setting unit 306 functions as a first target position generation unit which generates a first target position serving as a movement target of a first driving member on the basis of a target speed of the first zoom lens as a first driving member.

Similarly, for the second zoom lens 104, a target position counter value is generated using the target position setting unit 306 so that the second zoom lens 104 moves along a predetermined trajectory in conjunction with the movement of the first zoom lens 102.

Therefore, the target position setting unit 306 also functions as a second target position generation unit which generates a second target position serving as a movement target of the second zoom lens as the second driving member. As described later, in the present embodiment, the second target position is generated in accordance with an actual position of the first driving member or the first target position.

The position detection counter value and the target position counter value are set to the same coordinate origin using a coordinate origin setting unit 307 and the coordinates are aligned. A lead angle and power rate control unit is denoted by reference numeral 308 and sets a target lead angle and generates a drive counter value by adding a target lead angle to a position detection counter value. Furthermore, the lead angle and power rate control unit 308 performs feedback control of the lead angle and an amplitude of the drive waveform so that the lens moves following the target position counter value by setting a power rate.

Here, the lead angle and power rate control unit 308 functions as a control unit which controls the rotational speed and the rotational position of the motor on the basis of the target lead angle. Furthermore, the lead angle and power rate control unit 308 controls at least one of the target lead angle and the drive voltage (power rate) set for the motor.

That is to say, the lead angle and power rate control unit 308 functions as a first control unit which performs a first control step of controlling a position of the first driving member so that the first driving member follows the first target position. Furthermore, the lead angle and power rate control unit 308 functions as a second control unit which performs a second control step of controlling a position of the second driving member so that the second driving member follows the second target position.

A drive waveform generation unit is denoted by reference numeral 309 and adds the target lead angle to the position detection counter value to generate a drive counter value, subjects the generated drive counter value to SIN/COS conversion, and also generates a two-phase drive waveform whose amplitude is adjusted in accordance with the power rate.

Since feedback control is not possible until the coordinate origin is set using the coordinate origin setting unit 307, open control is performed during this period. In this case, the lead angle and power rate control unit 308 sets, as the drive counter value, the target position counter value obtained from the target position setting unit 306 and also sets a power rate for open control to subject the drive waveform to open control.

The drive waveform generated using the drive waveform generation unit 309 is supplied to a motor driver 310 as, for example, a PWM signal, and is converted into a motor drive signal using the motor driver 310 and supplied to the stepping motor 201. The drive waveform may be supplied to the motor driver 310 after AD conversion processing or may be supplied as drive waveform information from a communication port.

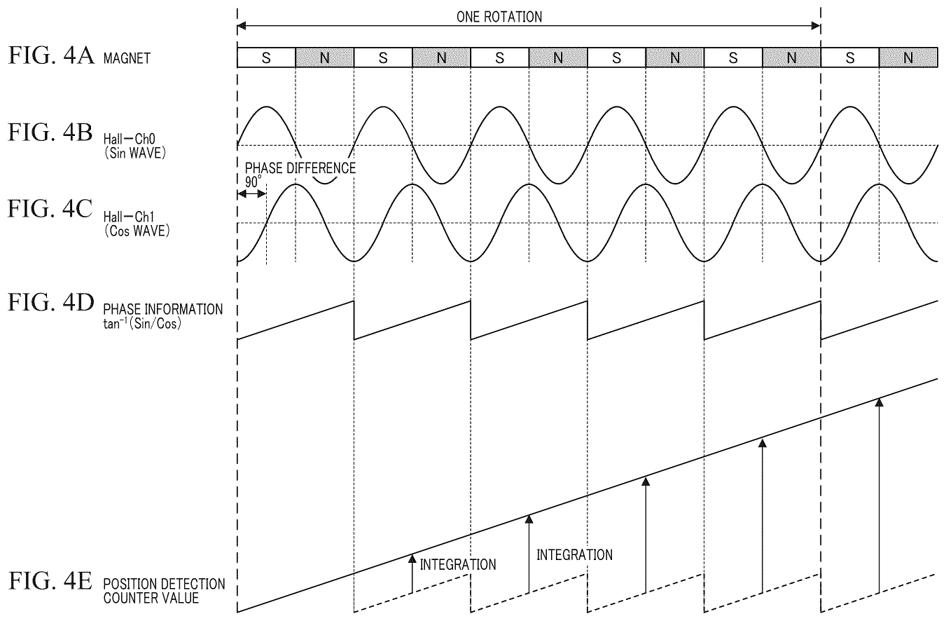

Here, the processing of the encoder 305 will be explained in detail with reference to FIG. 4. FIGS. 4A to 4E are diagrams showing an example of processing of the encoder 305 in an embodiment of the present invention. Here, in accordance with the configuration of FIG. 2B, an example in which a cylindrical magnet having the number of poles of the stepping motor 201 being 10 and the number of poles of the magnet 207 for detecting a rotational phase being 10 is assumed will be described.

FIG. 4A shows the magnet 207 for detecting a rotational phase of the motor and FIGS. 4B and 4C show the waveforms of the Hall signals detected using Hall-Ch0 and Hall-Ch1. With the configuration shown in FIG. 2B, as the Hall signals, a sine wave (Sin wave) and a cosine wave (Cos wave) which are 90° out of phase with each other are obtained.

The encoder 305 performs an arctangent operation (tan⁻¹(Sin/Cos)) using FIGS. 4B and 4C which are the sine wave and cosine wave signals quantized using the AD converter 304 to calculate phase information from 0 to 360°.

FIG. 4D shows the calculated phase information and this calculated phase information is integrated to calculate a position detection counter value (FIG. 4E) indicating an amount of rotation of the motor. This rotation amount information can be converted into position information of the lens by multiplying the rotation amount information by a thread pitch of the lead screw.

Therefore, the rotation amount information of the motor calculated using the encoder 305 is treated as a position detection counter value of the lens. The encoder 305 functions as an encoding unit which performs an encoding step of detecting a rotation state of the motor and converting the detected rotation state into actual position information. Furthermore, although the phase information has been explained herein as information from 0 to 360°, this is determined using the resolution of the position detection counter value and the present invention is not limited thereto.

The processing of the coordinate origin setting unit 307 will be explained in detail below. When the motor control device 303 is powered on, it first executes a sequence for setting the coordinate origin of the lens.

That is to say, the lens is driven to search for a lens position in which the detection signal of the PI 205 explained in FIG. 2 switches from High to Low and the position detection counter value and the target position counter value are initialized to predetermined values using this retrieved switching position as the coordinate origin. Thus, the coordinates of both are aligned, making it possible to control the position of the lens.

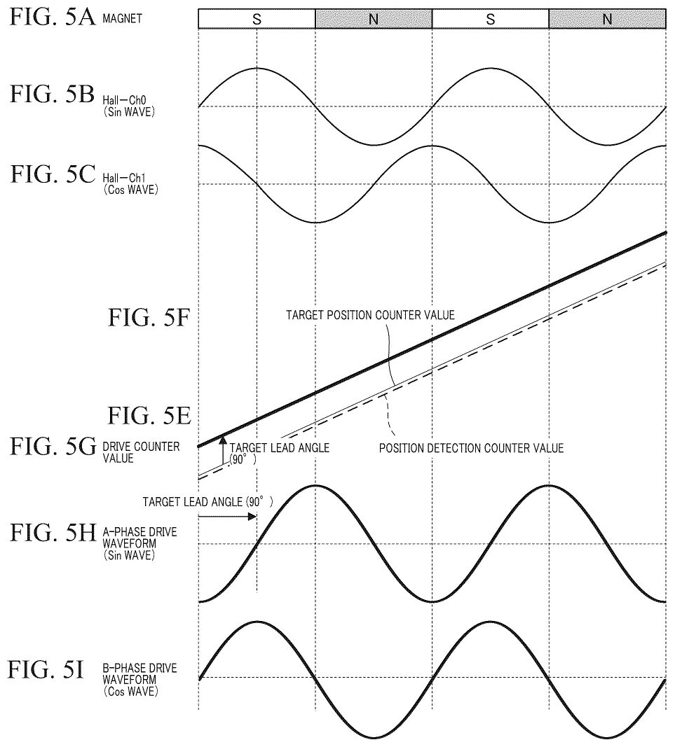

FIGS. 5A to 5C and 5E to 5I are diagrams showing an example of processing of the lead angle and power rate control unit 308 and the drive waveform generation unit 309 in an embodiment of the present invention. FIGS. 5A, 5B, 5C, and 5E are the same as the signals explained with the same reference numerals in FIG. 4, and thus the explanation will be omitted herein. FIG. 5F shows the target position counter value. As described above, the target lead angle and power rate are calculated so that the position detection counter value (FIG. 5E) follows the target position counter value (FIG. 5F).

In the following description, an example in which target lead angle is 90° will be explained. The lead angle and power rate control unit 308 generates a drive counter value (FIG. 5G) by superimposing the target lead angle of 90° on the position detection counter value (FIG. 5E).

The position detection counter value (FIG. 5E) is a counter value obtained by integrating phase information from 0 to 360° and the drive counter value (FIG. 5G) also includes phase information from 0 to 360°. Therefore, the drive waveform generation unit 309 performs sine and cosine conversion on this drive counter value (FIG. 5G) to generate two phases, an A-phase drive waveform (sine wave) (FIG. 5H) and a B-phase drive waveform (cosine wave) (FIG. 5I) which are out of phase with respect to the motor rotational phase by the lead angle.

The drive waveform generation unit 309 generates an offset position counter value by adding a target lead angle as an offset value to the position detection counter value and controls the motor on the basis of the offset position counter value and the target position counter value. The offset position counter value is determined on the basis of the position detection counter value and the target lead angle and the target lead angle is set on the basis of the target position counter value and the position detection counter value.

Also, in these drive waveforms, the power rate is set to achieve the target amplitude and the drive waveforms are output to the motor driver 310. Here, although the phase information has been described as information from 0 to 360°, this is determined using the resolution of the position detection counter value (FIG. 5E) and the present invention is not limited thereto.

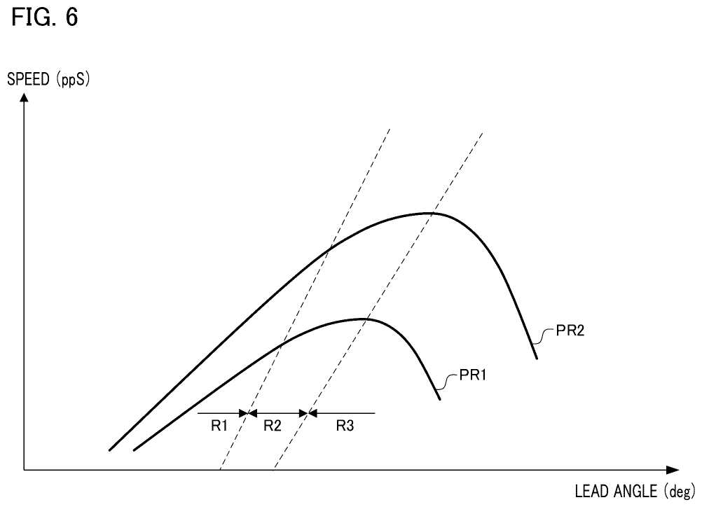

FIG. 6 is a diagram showing an example of a relationship of a lead angle and a motor rotation speed according to an embodiment of the present invention. In addition, FIG. 6 shows the relationship of the lead angle and the motor rotation speed for examples of power rates PR1% and PR2% (PR1<PR2). PR1% is, for example, 50%, and PR2% is, for example, 60%. The power rate adjusts the amplitude of the drive waveform. For example, a power rate of 60% generates a waveform which limits the amplitude of the drive waveform to 60%.

In FIG. 6, it can be seen that, in a region R1, the motor rotation speed increases in proportion to the increase in the lead angle. Here, if the lead angle is further increased, the motor rotation speed increases relative to the lead angle and reaches a region R2 in which the increase gradually becomes saturated. If the lead angle is further increased and a saturation point SP1 is exceeded, the motor rotation speed enters a region R3 in which it starts to drop.

Also, the larger the power rate, the steeper the gradient of the lead angle vs. the motor rotation speed in the region R1 becomes and the saturation point SP1 shifts toward the larger lead angle. The lead angle and the speed are in a proportional relationship within the region R1. That is to say, the relationship of the lead angle and the speed can be expressed by the following Equation (1).

$$Speed = lead angle x γ + β \qquad Equation ( 1 )$$

where γ is a slope and β is an intercept.

Thus, the relationship of the lead angle and the rotation speed is measured in advance, and based on the measurement data, the slope γ, the intercept β, and the region R1 that is the effective region of Equation (1) corresponding to the region R1 of Equation (1) are stored as a lead angle vs. a speed table.

A plurality of lead angle vs. speed tables are stored for each power rate and can be selected in accordance with the target speed. Moreover, the smaller power rate is assumed to be selected with priority. Here, although the relationship of the lead angle and the speed will be explained using Equation (1), the corresponding information between the motor rotation speed and the lead angle may be table data which stores the relationship between the lead angle and the speed in advance.

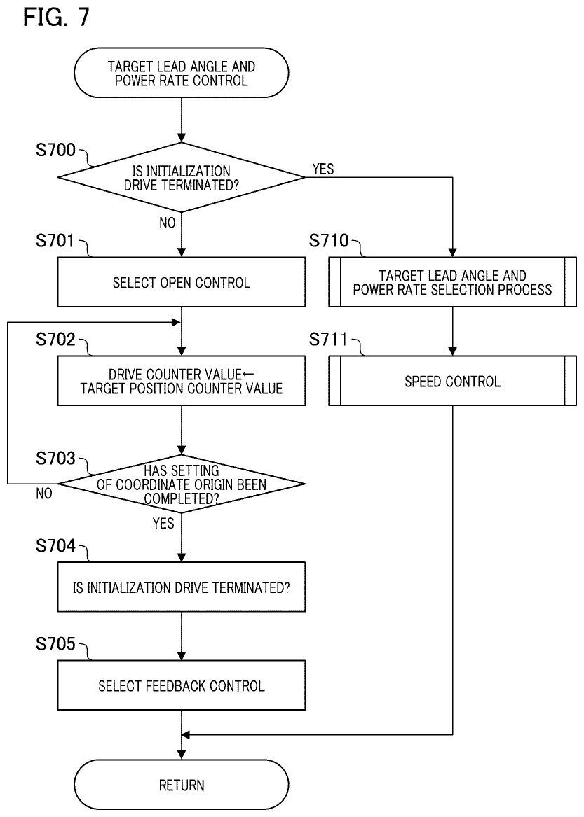

FIG. 7 is a flowchart for explaining an example of processing of the lead angle and power rate control unit 308 according to an embodiment of the present invention. The operations of the steps in the flowchart of FIG. 7 are performed in sequence by a CPU or the like serving as a computer of the motor control device 303 executing a computer program stored in the memory.

As described above with reference to FIG. 3, the position detection counter value and the target position counter value are set to the same coordinate origin in the coordinate origin setting unit 307 and the coordinates are aligned. Here, since feedback control is not possible until the coordinate origin is set by the coordinate origin setting unit 307, open control is performed during this period.

Thus, the lead angle and power rate control unit 308 switches a control method thereof to open control during initialization drive and to feedback control if initialization drive is terminated. That is to say, in Step S700, it is determined whether the initialization drive is terminated, and if it is determined to be No in Step S700, the process proceeds to Step S701, in which the open control is selected.

If open control is selected in Step S701, the target position counter value is set as the drive counter value in Step S702. Subsequently, in Step S703, it is determined whether detection and setting of the coordinate origin in the coordinate origin setting unit 307 has been completed. If the result of Step S703 is No, the process returns to Step S702 and the processes of Steps S702 and S703 are repeatedly performed.

If it is determined in Step S703 that the setting of the coordinate origin has been completed, the process proceeds to Step S704, in which the initialization drive is terminated, and in Step S705, feedback control is selected and the process returns to Step S700, in which the flow of FIG. 7 is repeatedly performed.

On the other hand, if it is determined in Step S700 that the initialization driving is terminated, the process proceeds to Step S710, in which a target lead angle and power rate selection process is performed, and then speed control is performed in Step S711. After that, the process returns to Step S700 and the flow of FIG. 7 is performed repeatedly.

FIG. 8 is a flowchart for explaining an example of processing of a target lead angle and power rate selection process in Step S710. The operations of the steps in the flowchart of FIG. 8 are performed in sequence by the CPU or the like serving as a computer of the motor control device 303 executing a computer program stored in the memory.

First, in Step S800, the lead angle and power rate control unit 308 determines whether the target speed has been updated. If the target speed has been updated, the process proceeds to Step S801, in which it is determined whether the operation is currently stopped. If it is determined in Step S801 that the operation is being stopped, the initial target lead angle and power rate are calculated from the target speed in Step S802, that is, the calculated initial target lead angle and power rate are selected, and the flow of FIG. 8 is terminated.

If it is determined to be No in Step S800 or Step S801, the current lead angle and power rate are not changed, that is, the current lead angle and power rate are selected, and the flow of FIG. 8 is terminated.

A target speed is calculated from an amount of deviation D1 between a current position and a target position and a target time t1 required for moving to the target position using the following Equation (2):

$$Target speed = amount of deviation = D 1 / target time t 1 \qquad Equation ( 2 )$$

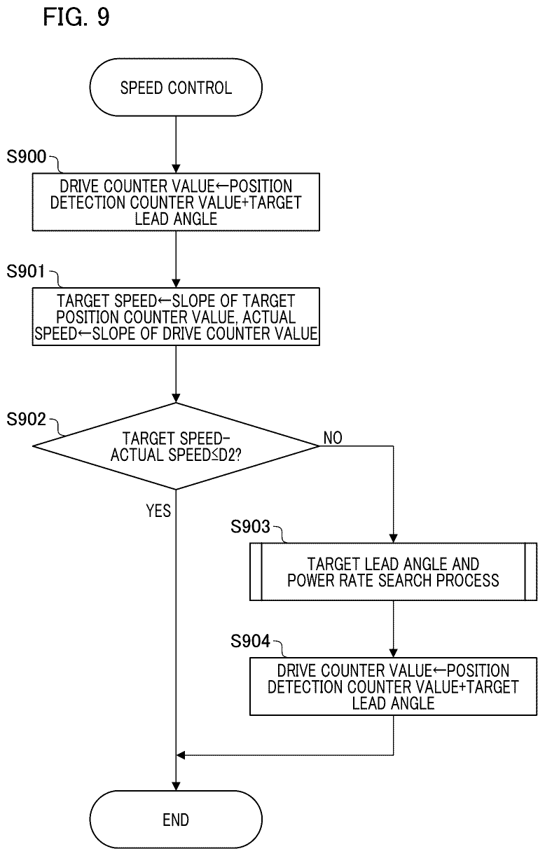

FIG. 9 is a flowchart for explaining an example of processing of the lead angle and power rate control unit in Step S711. The operations of the steps in the flowchart of FIG. 9 are performed in sequence using the CPU or the like serving as a computer of the motor control device 303 executing a computer program stored in the memory.

In the flowchart of FIG. 9, feedback control of the lead angle and the power rate of the drive waveform is performed using the target lead angle and power rate selected using a target lead angle and power rate selection process in Step S710.

That is to say, first, in Step S900, a drive counter value is generated by adding the target lead angle to the position detection counter value. Subsequently, in Step S901, a slope of the target position counter value is set to a target speed and a slope of the position detection counter value is set to an actual speed. Here, Step S901 functions as a first a control step of controlling the position of the first driving member so that the first driving member follows the first target position.

In Step S902, it is determined whether a speed deviation that is a difference between the target speed set in Step S901 and the actual speed is a predetermined threshold value D2 or less. If it is determined to be No in Step S902, that is, if it is determined that there is a speed deviation greater than D2, the process proceeds to Step S903, in which a lead angle and power rate search process is performed to obtain a target lead angle and power rate.

Subsequently, the process proceeds to Step S904, in which the target lead angle is added to the position detection counter value to generate a drive counter value, and then the flow of FIG. 9 is terminated. On the other hand, if it is determined to be Yes in Step S902, the speed is not changed and the flow of FIG. 9 is terminated.

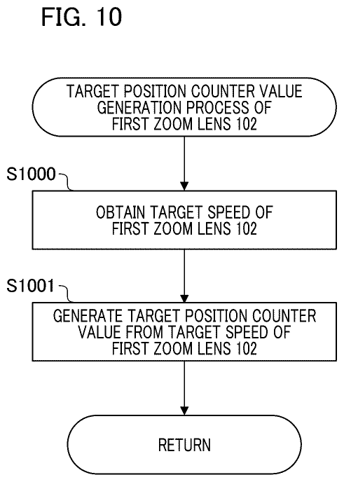

FIG. 10 is a flowchart for explaining an example of a target position counter value generation process of the first zoom lens 102 according to an embodiment of the present invention. The operations of the steps in the flowchart of FIG. 10 are performed in sequence using the CPU or the like serving as a computer of the motor control device 303 executing a computer program stored in the memory. The process of FIG. 10 is repeatedly performed using the target position setting unit 306, separately from the flow shown in FIG. 7.

First, in Step S1000, the target position setting unit 306 acquires the target speed of the first zoom lens 102. In the present embodiment, a specified zoom speed from among a plurality of predetermined zoom speeds is acquired as a target speed.

Subsequently, the process proceeds to Step S1001, in which a target position counter value of the first zoom lens 102 is generated from the target speed of the first zoom lens 102 acquired in Step S1000.

Here, Step S1001 functions as a first target position generation step of generating a first target position which serves as a movement target for the first driving member on the basis of the target speed of the first driving member (first zoom lens). After that, the process returns to Step S1000 and the flow of FIG. 10 is performed repeatedly.

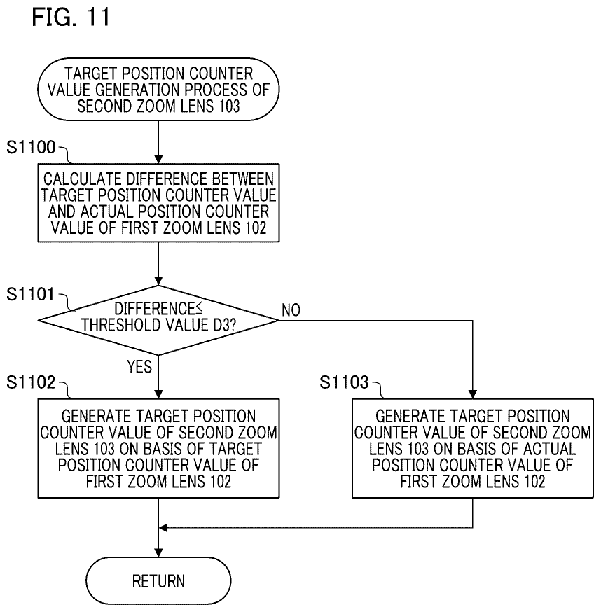

FIG. 11 is a flowchart for explaining an example of a target position determination process for the second zoom lens 103 according to an embodiment of the present invention. The operations of the steps in the flowchart of FIG. 11 are performed in sequence using the CPU or the like serving as a computer of the motor control device 303 executing a computer program stored in the memory.

The flow in FIG. 11 shows an example of a processing flow performed on the basis of the target position counter value generated in Step S1001 in FIG. 10. The process of FIG. 11 is performed separately from the flow shown in FIG. 7 and is repeatedly performed using the target position setting unit 306 together with the flow of FIG. 10.

First, in Step S1100, a difference between the target position counter value and the actual position counter value of the first zoom lens 102 is calculated. Subsequently, in Step S1101, it is determined whether the calculated difference is a threshold value D3 or less. The threshold value D3 is calculated from the permissible circle of confusion and the amount of influence that the second zoom lens 103 has on the focus position. Here, the determination may be provided on the basis of, for example, the image magnification ratio obtained from optical information.

If it is determined in Step S1101 that the difference is the threshold value D3 or less, a target position counter value of the second zoom lens 103 is generated from the target position counter value (first target position) of the first zoom lens 102 in Step S1102.

That is to say, in Step S1102, when the difference between the first target position and the actual position of the first driving member is the threshold value or less, the target position setting unit 306 generates a second target position on the basis of the first target position. After that, the step returns to Step S1000 in FIG. 10 and the flow in FIG. 10 is performed again.

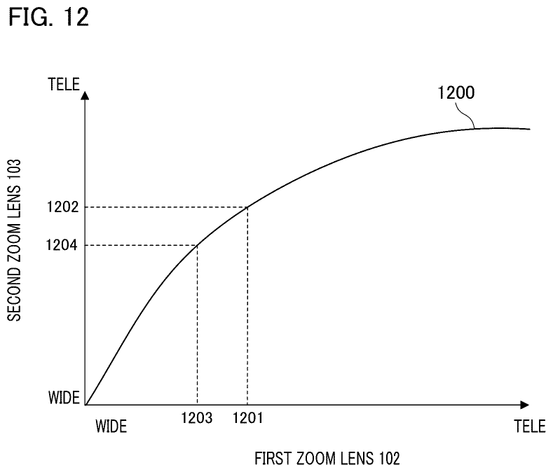

FIG. 12 is a diagram showing an example of a positional relationship of the first zoom lens 102 and the second zoom lens 103 according to an embodiment of the present invention. In FIG. 12, an example of the positional relationship of the first zoom lens 102 and the second zoom lens 103 determined from optical design information for obtaining a desired angle of view is denoted by reference numeral 1200.

That is to say, a position of the second zoom lens 103 on the vertical axis corresponding to a position of the first zoom lens 102 on the horizontal axis is denoted by reference numeral 1200. In the present embodiment, the positional relationship as shown in FIG. 12 is stored in advance in a memory as, for example, table data or a functional equation.

Therefore, in Step S1102, for example, a target position 1202 of the second zoom lens corresponding to a target position 1201 of the first zoom lens 102 can be acquired on the basis of the table data of the positional relationship as shown in FIG. 12 stored in the memory or a function equation.

On the other hand, if it is determined in Step S1101 that the position difference is greater than the threshold value D3, the process proceeds to Step S1103. In step S1103, a target position 1204 of the second zoom lens 103 is determined from an actual position 1203 of the zoom lens 102 on the basis of table data or a function equation of the positional relationship as shown in FIG. 12.

That is to say, in Step S1103, when the difference between the first target position and the actual position of the first driving member is greater than the threshold value, the target position setting unit 306 generates a second target position on the basis of the actual position of the first driving member. After that, the step returns to Step S1000 in FIG. 10 and the flow in FIGS. 10 and 11 is performed again.

Here, in Steps S1102 and S1103, the target position setting unit 306 functions as a second target position generating step in which the target position setting unit 306 generates a second target position serving as a movement target for the second driving member in accordance with the actual position or the first target position of the first driving member.

As described above, in the embodiment of the present invention, a target position counter value of the first zoom lens 102 is generated from the zoom speed, as shown in FIG. 10. Furthermore, as shown in FIG. 11, a target position counter value of the second zoom lens is generated from the actual position or the target position counter value (first target position) of the first zoom lens 102. Therefore, it is possible to realize interlocking drive with suppressed velocity disturbance.

Furthermore, according to the above embodiment, each lens is controlled without being affected by speed variations of other lenses so that it is possible to control the lenses at ideal positions, reduce noise, and improve zoom tracking accuracy.

In the above embodiment, an example in which the first driving member is a first zoom lens which performs zooming by moving in the optical axis direction and the second driving member is a second zoom lens which assists zooming in conjunction with the first lens has been described. Here, the first driving member and the second driving member do not have to be zoom lenses and may be, for example, a first lens and a second lens, respectively.

Also, it may be used for generating a target position of a focus lens which corrects the change in the focus position in accordance with the movement of the zoom lens. That is to say, the first lens may be a first zoom lens which performs zooming by moving in the optical axis direction and the second lens may be a focus lens which corrects the movement of the focus position in conjunction with the first lens.

Furthermore, the control device of the above embodiment may be applied to the control of a pan head capable of pan/tilt driving or to the control of an automobile, a robot arm, or the like. That is to say, the driving member to be driven by the control device in the above embodiment is not limited to a lens, but may be anything. In this case, the first driving member and the second driving member are separate driving members which are targets to be driven.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the control device or the like through a network or various storage media. Then, a computer (or a CPU, an MPU, or the like) of the control device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-081122, filed on May 17, 2024, which is hereby incorporated by reference herein in its entirety.

What is claimed is:

1. A control device, comprising:
at least one processor or circuit configured to function as:
a first target position generation unit configured to generate a first target position serving as a movement target of a first driving member on the basis of a target speed of the first driving member;
a first control unit configured to control a position of the first driving member so that the first driving member follows the first target position;
a second target position generation unit configured to generate a second target position serving as a movement target of a second driving member in accordance with an actual position of the first driving member or the first target position; and
a second control unit configured to control a position of the second driving member so that the second driving member follows the second target position.

2. The control device according to claim 1, wherein the second target position generation unit is configured to generate the second target position on the basis of the actual position when a difference between the first target position and the actual position of the first driving member is greater than a threshold value.

3. The control device according to claim 1, wherein the second target position generation unit is configured to generate the second target position on the basis of the first target position when a difference between the first target position and the actual position of the first driving member is equal to or less than a threshold value.

4. The control device according to claim 1, wherein the first driving member is a first lens, and
the second driving member is a second lens which is different from the first lens.

5. The control device according to claim 4, wherein the first lens is a first zoom lens which is configured to perform zooming by moving in an optical axis direction, and
the second lens is a second zoom lens which is configured to assist zooming in conjunction with the first lens.

6. The control device according to claim 4, wherein the first lens is a first zoom lens which is configured to perform zooming by moving in an optical axis direction; and
the second lens is a focus lens which is configured to correct movement of a focal position in conjunction with the first lens.

7. A control method, comprising:
generating a first target position serving as a movement target of a first driving member on the basis of a target speed of the first driving member;
controlling a position of the first driving member so that the first driving member follows the first target position;
generating a second target position serving as a movement target of a second driving member in accordance with an actual position of the first driving member or the first target position; and
controlling a position of the second driving member so that the second driving member follows the second target position.

8. A non-transitory computer-readable storage medium configured to store a computer program comprising instructions for executing following processes:
generating a first target position serving as a movement target of a first driving member on the basis of a target speed of the first driving member;
controlling a position of the first driving member so that the first driving member follows the first target position;
generating a second target position serving as a movement target of a second driving member in accordance with an actual position of the first driving member or the first target position; and
controlling a position of the second driving member so that the second driving member follows the second target position.
